(19) United States
(12) Patent Application Publication
(10) Pub. No.: US 2024/0255188 A1
(43) Pub. Date: Aug. 1, 2024

(54) HORIZONTAL DRILLING FOR GEOTHERMAL WELLS

(71) Applicant: DEEP Earth Energy Production Corp., Saskatoon (CA)

(72) Inventor: Kirsten Marcia, Saskatoon (CA)

(73) Assignee: DEEP Earth Energy Production Corp., Saskatoon (CA)

(21) Appl. No.: 18/601,797

(22) Filed: Mar. 11, 2024

Related U.S. Application Data
(63) Continuation of application No. PCT/CA2021/051260, filed on Sep. 10, 2021.

(51) Int. Cl. F24T 10/20; F24T 10/00; F24T 50/00

(52) U.S. Cl. CPC F24T 10/20; F24T 50/00; F24T 2010/50

(57) ABSTRACT

A system includes an injection well, a production well, and a binary cycle system. The injection well has a horizontally drilled injection section traversing the geothermal reservoir, through which a cooled geothermal fluid is injected, from a surface location, into the geothermal reservoir to be heated by the geothermal reservoir. The production well has a horizontally drilled production section traversing the geothermal reservoir and a production pump disposed within a vertical section. The production pump pumps the heated geothermal fluid, which enters the production well from the geothermal reservoir, to the surface location. The binary cycle system includes a heat exchanger and a turbine. The heat exchanger is configured to transfer heat from the heated geothermal fluid to a condensed working fluid to create a vaporized working fluid. The turbine, rotated by the vaporized working fluid, drives a generator to produce the geothermal energy.

### BACKGROUND

Geothermal energy is energy that is produced using heat from within the Earth's crust. Geothermal energy may be categorized by resource type and generation type. Resource type includes shallow geothermal heat-pump (also known as geo-exchange resources), hydrothermal resources, enhanced/engineered geothermal systems, and unconventional/advanced geothermal systems. These geothermal resources may be located in volcanic formations, sedimentary formations, hot wet rock formations, and hot dry rock formations. Current methods of generating geothermal energy include dry steam geothermal, flash steam geothermal, and binary cycle geothermal. Dry steam geothermal methods include drilling a vertical well into the Earth's surface to access steam. The steam travels to the surface of the Earth through the well. The steam flows directly to a turbine to drive a generator to produce electricity.

Flash steam geothermal methods use a pump to pull hot fluid, from a vertical well, into a tank at the surface. The hot water cools very quickly, and, as the fluid cools, the fluid turns into a vapor. The vapor drives a turbine and powers a generator. Binary cycle geothermal methods use two types of fluid. Hot water from underground is delivered to the surface using a vertical or directional well. The heat from the hot water is extracted using a heat exchanger. The heat then heats a working fluid that has a lower boiling point than the water, so the working fluid vaporizes at much lower temperatures. The vaporization of the working fluid is used to spin a turbine that drives a generator to produce electricity. The cooled water is recycled back into the reservoir to gently reload with heat and be produced again.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The present invention presents, in accordance with one or more embodiments, a system and a method for producing geothermal energy from a geothermal reservoir. In one embodiment, the system includes an injection well, a production well, and a binary cycle system. The production well has a horizontally drilled production section traversing the geothermal reservoir and a production pump disposed within a vertical section. The production pump pumps a heated geothermal fluid, which enters the production well from the geothermal reservoir, to the surface location. The injection well has a horizontally drilled injection section traversing the geothermal reservoir, through which a cooled geothermal fluid is injected, from a surface location, into the geothermal reservoir to be heated by the geothermal reservoir. The binary cycle system includes a heat exchanger and a turbine. The heat exchanger is configured to transfer heat from the heated geothermal fluid to a condensed working fluid to create a vaporized working fluid. The turbine, rotated by the vaporized working fluid, drives a generator to produce the geothermal energy.

The method includes providing an injection well having a horizontally drilled injection section traversing the geothermal reservoir, providing a production well having a horizontally drilled production section traversing the geothermal reservoir and a production pump disposed within a vertical section of the production well, producing a heated geothermal fluid from the geothermal reservoir using the production well, transferring heat from the heated geothermal fluid to a condensed working fluid to create a vaporized working fluid, transporting the vaporized working fluid to a turbine to drive a generator and create the geothermal energy, and injecting a cooled geothermal fluid from a surface location into the geothermal reservoir using the injection well.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows an injection well in accordance with one or more embodiments.

FIG. 2 shows a production well in accordance with one or more embodiments.

FIG. 3 shows a binary cycle system in accordance with one or more embodiments.

FIG. 4 shows a geothermal energy production field in accordance with one or more embodiments.

FIG. 5 shows a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Conventional geothermal energy production systems and methods utilize vertically or directionally drilled wells to access geothermal reservoirs. When a conventional geothermal energy production system utilizes a directionally drilled well, the well is drilled at an angle of less than 85 degrees. A geothermal fluid is pumped into the geothermal reservoir and produced from the geothermal reservoir using the vertical/directional wells. Those conventional vertical/directional wells commonly extend into reservoirs having temperatures greater than 150 degrees Celsius, with the reservoir depth up to 7,000 m.

Horizontally drilled wells are wells that have horizontal section drilled through a reservoir. The horizontal section is drilled an angle ranging from 85 degrees to 95 degrees. Thus, the “reservoir section” of a horizontal well may have a length greater than that of vertical/directional well, such that horizontal wells provide the ability to inject more fluid and produce more fluid due to the increase in surface area available in the reservoir.

While the presently claimed reservoirs may be through reservoirs having a substantially lower temperature (thus conventionally avoided for geothermal wells), the present use of horizontal wells may allow for a larger volume of fluid to be produced from the well, thus realizing gains in the amount of energy produced, despite the lower temperatures. It is beneficial to use horizontal wells, rather than vertical wells, to inject and produce the geothermal fluid into/from these geothermal reservoirs to increase the production of geothermal energy. As such, embodiments disclosed herein present systems and methods that utilize horizontal production and horizontal injection wells to produce geothermal energy.

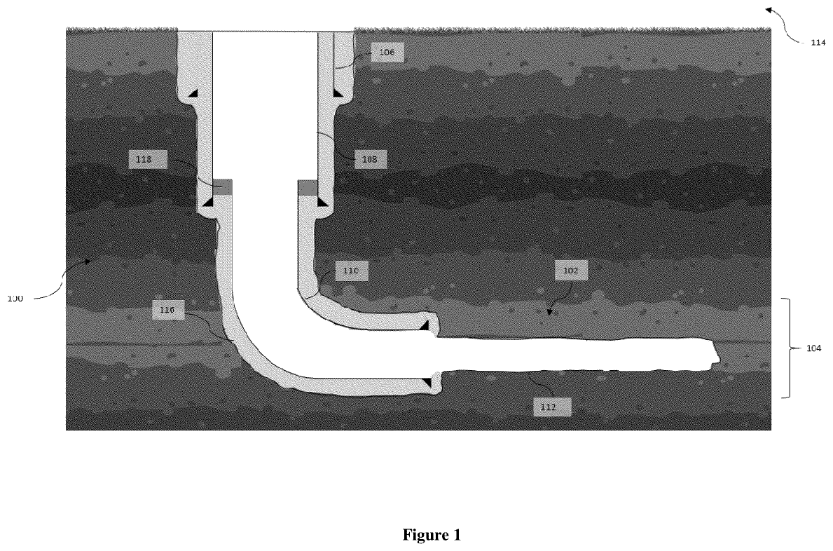

FIG. 1 shows an injection well (100) having a horizontally drilled injection section (102) traversing a geothermal reservoir (104) in accordance with one or more embodiments. The horizontally drilled injection section (102) is the section of the injection well (100) that is drilled at or near horizontal in relation to the surface of the Earth. The geothermal reservoir (104) may be any rock formation, or cluster of rock formations, located within the surface of the Earth. In one or more embodiments, the geothermal reservoir (104) is a sedimentary basin, such as the Williston Basin located on the North American continent.

More specifically, the geothermal reservoir (104) may be the Deadwood formation located in the Williston Basin. The geothermal reservoir (104) may have a vertical depth in excess of 2,000 m and/or less than 5,000 m or even 4,000 m below the surface of the Earth. The vertical depth of the horizontally drilled injection section (102) may also be around 3,500 m below the surface of the Earth to access the geothermal reservoir (104). The temperature of the geothermal reservoir (104) may be around 120 degrees Celsius, for example, or other temperatures between 90 and 200 degrees Celsius. The injection well (100) may have a wellbore schematic including a surface casing (106), an intermediate casing (108), a production liner (110), and an open hole (112) section. However, the injection well (100) may have any wellbore schematic that includes a horizontally drilled injection section (102) without departing from the scope of the disclosure herein.

The surface casing (106) is made of a plurality of joints of casing. A joint of casing is a large diameter pipe made of material that can withstand the temperatures and pressures seen downhole, such as steel. Each joint of casing is connected to each other to form a long string of casing. The joints of casing are connected to each other by threading the joints of casing together. The surface casing (106) has a larger inner diameter than the outer diameter of the intermediate casing (108) such that the intermediate casing (108) may fit inside the surface casing (106).

The surface casing (106) extends from a surface location (114) to a depth within the surface of the Earth. The surface location (114) may be any location along the surface of the Earth, such as in a wellhead. The depth of the deepest point of the surface casing (106) may be around 500 m below the surface location (114), however the surface casing (106) set depth may be shallower or deeper without departing from the scope of this disclosure herein. The drilled hole for the surface casing (106), called the surface hole, may be drilled using a drill bit having a diameter larger than the outer diameter of the surface casing (106). The drilling fluid used to drill the surface hole may be a freshwater gel. The surface hole may be drilled to a depth deeper than the planned setting depth of the surface casing (106). The surface casing (106) is cemented in place using cement (116) after the surface casing (106) is run into the surface hole.

The intermediate casing (108) is also made of a plurality of joints of casing of the same size connected together. In other embodiments, the intermediate casing (108) string may be made out of two different sizes, one set with a thinner wall and another set with a thicker wall, of casing joints. The joints of casing having the thinner wall thickness may be run into the intermediate hole prior to the joints of casing having the thicker wall thickness being run into the intermediate hole. This may be done to lower the weight and cost of the entire intermediate casing (108) string.

The intermediate casing (108) extends from the surface location (114) to a depth within the surface of the Earth. The deepest point of the intermediate casing (108) is at a depth deeper than the deepest point of the surface casing (106). For example, the intermediate casing may be set 2,010 m below the surface location (114), however the intermediate casing (108) set depth may be shallower or deeper without departing from the scope of this disclosure herein. The drilled hole for the intermediate casing (108), called the intermediate hole, may be drilled using a drill bit having a larger diameter than the outer diameter of the intermediate casing (108). The drilling fluid used to drill the intermediate hole may be a water-based fluid or a hydrocarbon-based fluid. The intermediate hole may be drilled to a depth deeper than the planned setting depth of the intermediate casing (108). The intermediate casing (108) is cemented in place using cement (116) after the intermediate casing (108) is run into the intermediate hole.

The production liner (110) may also be made out of a plurality of joints of solid casing. The production liner (110) does not extend to the surface location (114). Rather, the production liner (110) is hung off of the intermediate casing (108) using a liner hanger (118). The production liner (110) is hung off of a deeper point of the intermediate casing (108), such as 100 m above the last joint of casing. This is done to lower the cost of the production liner (110), to lower the weight of the production liner (110), and to accommodate the production pump (204) in the intermediate casing (108) string in the production wells (200). The production liner (110) has an outer diameter smaller than the inner diameter of the intermediate casing (108) such that the production liner (110) may fit inside the intermediate casing (108).

The drilled hole for the production liner (110), called the liner hole, may be drilled using a drill bit having a diameter larger than the outer diameter of the production liner (110). The liner hole may be drilled starting at vertical, but the liner hole includes the kickoff point and which begins the transition from a vertical hole to a horizontal hole. The terms vertical and horizontal are used in reference to the Earth's surface. The liner hole may be drilled to a depth deeper than the planned setting depth of the production liner (110). The production liner (110) may be set at a true vertical depth (the depth directly beneath the surface location (114)) of 3,500 m and a measured depth of 3,773 m, however the production liner (110) set depth may be shallower or deeper without departing from the scope of this disclosure herein. The drilling fluid used to drill the liner hole may be a water-based fluid or a hydrocarbon-based fluid.

The production liner (110) may be lowered to the planned measured depth using a running tool. The production liner (110) is set at the bottom of the intermediate casing (108) using a liner hanger (118). The liner hanger (118) is a device that is used to attach a liner, such as the production liner (110), to the internal wall of a previous casing string, such as the intermediate casing (108). The liner hanger (118) may be any type of liner hanger (118) known in the art such as a mechanical or hydraulic liner hanger (118). The liner hanger (118) includes a seal to prevent migration of fluid between the production liner (110) annulus and the intermediate casing (108) annulus. After the production liner (110) is at the planned depth, the production liner (110) is cemented in place using cement (116) prior to setting the seal on the liner hanger (118).

The injection well (100) is completed using a barefoot completion scheme as shown in FIG. 1. This means that a portion of the horizontally drilled injection section (102) traversing the geothermal reservoir (104) has no liner or casing. FIG. 1 shows the injection well (100) having an open hole (112) defining a large portion of the horizontally drilled injection section (102). The open hole (112) has no casing or liner completing the open hole (112). The open hole (112) is drilled after the production liner (110) has been cemented in place. The open hole (112) is drilled using a drill bit having a diameter smaller than the inner diameter of the production liner (110) such that the drill bit may fit through the production liner (110) to drill the open hole (112) section.

The open hole (112) is drilled horizontally through the geothermal reservoir (104). The open hole (112) may be drilled at a true vertical depth in excess of 2,000 m (and/or less than 5,000 m or even 4,000 m) and a measured depth of at least 4,000 m and up to 8,000 m. The length of the horizontally drilled section (102, 202) may be at least 2,000 m and/or less than 6,000 m long. Upon completion of drilling, the open hole (112) provides the ability for fluid to be injected into the injection well (100) and enter the geothermal reservoir (104). The cooled geothermal fluid is injected into the geothermal reservoir (104) to be heated by the geothermal reservoir (104). The fluid that is injected into the injection well (100), and subsequently injected into the geothermal reservoir (104), is a cooled geothermal fluid (312) such as brine. The volume of brine being injected and subsequently produced may be greater than 25 liters/second, greater than 100 liters/second, greater than 250 liters/second, greater than 500 liters/second, greater than 750 liters/second, or even greater than 1000 liters/second. The cooled geothermal fluid may be maintained at a temperature sufficient to prevent precipitation of salts present therein.

In further embodiments, the cooled geothermal fluid (312) may include carbon dioxide in the liquid state. The carbon dioxide may completely make up the cooled geothermal fluid (312), or the carbon dioxide may only make up a percentage of the cooled geothermal fluid (312). Further, the cooled geothermal fluid (312) may alternate between brine and carbon dioxide based on the availability of the carbon dioxide. The carbon dioxide may be injected into the geothermal reservoir (104) for carbon dioxide sequestration (i.e., the long-term removal of carbon dioxide from the atmosphere to slow or reverse atmospheric carbon dioxide pollution).

The carbon dioxide may come from a third party, or the carbon dioxide may by gathered from the byproduct of the geothermal energy production system presented herein. For example, because the present wells may be drilled in sedimentary basins, there may be third parties, including natural gas producers, who have carbon dioxide waste that is otherwise flared into the atmosphere

The carbon dioxide may begin as a gas and be compressed into the liquid phase for injection through the injection well (100) and into the geothermal reservoir (104). The carbon dioxide, in the gas phase, may be delivered to the injection well (100) in pipelines. Equipment, such as a condenser, located on the surface location (114) may be present to condense the carbon dioxide into a liquid.

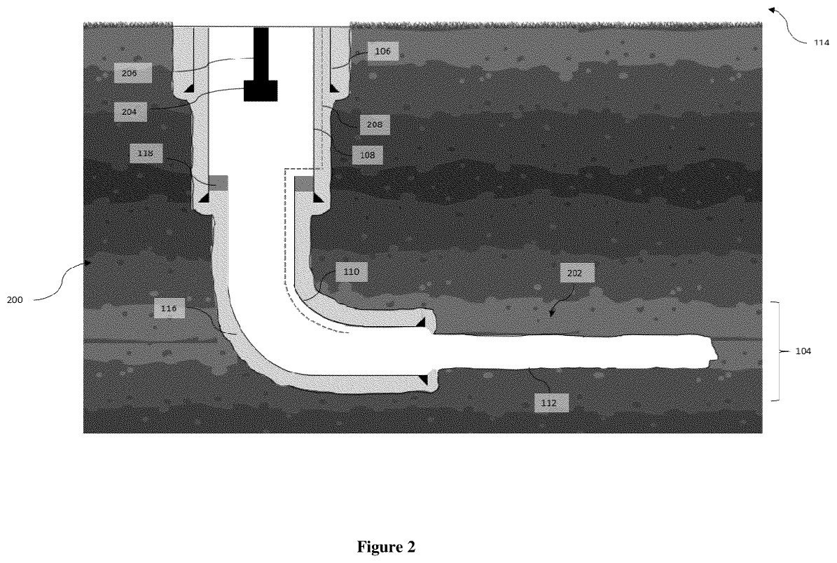

FIG. 2 shows a production well (200) having a horizontally drilled production section (202) traversing a geothermal reservoir (104) in accordance with one or more embodiments. Components of FIG. 2 that are the same as or similar to components presented in FIG. 1 have not been redescribed for purposes of readability and have the same description and function as described above. The production well (200) is also completed with a barefoot completion scheme. The production well (200) also has a similar wellbore schematic to the injection well (100) in that the production well (200) has surface casing (106), intermediate casing (108), production liner (110), and an open hole (112).

The surface casing (106), intermediate casing (108), production liner (110), and an open hole (112) for the production well (200) have the same design and description as the surface casing, intermediate casing (108), production liner (110), and an open hole (112) of the injection well (100). However, the production well (200) is used to produce fluids from the geothermal reservoir (104) rather than inject fluids into the geothermal reservoir (104) using the open hole (112). The cooled geothermal fluid that is injected into the geothermal reservoir (104) by the injection well (100) is heated while in the geothermal reservoir (104) to become a heated geothermal fluid. The heated geothermal fluid enters the production well (200) through the open hole (112). The heated geothermal fluid (314) may be produced to the surface location (114) naturally or using artificial lift. The heated geothermal fluid (314) may be brine, carbon dioxide in the liquid phase, or a mixture of the two.

The production well (200) may have a production pump (204) disposed within the vertical section of the production well (200) to aid in producing the heated geothermal fluid. More specifically, the production pump (204) pumps the heated geothermal fluid to the surface location (114). In one or more embodiments, the production pump (204) may be located on production tubing (206) that has been installed in the production well (200). The production tubing (206) extends from the surface location (114) to a depth within the production well (200). The production tubing (206) may have other pieces of equipment installed, such as a sub-surface safety valve, without departing from the scope of the disclosure herein. As shown in FIG. 2, the production pump (204) may be disposed within the intermediate casing (108). More specifically, the production pump (204) may be set at a true vertical depth between 200 m and 1,200 m below the surface of the Earth.

The production pump (204) may be a line shaft pump or an Electric Submersible Pump (ESP). A line shaft pump is a centrifugal pump with a pump bowl assembly mounted below the heated geothermal fluid level in the production well (200). The line shaft pump includes an electric motor drive shaft which is installed at the surface location (114) on the wellhead with the motor connected to the centrifugal pump via a long shaft. An auxiliary lube system is also required to lubricate the shaft. An ESP includes the pump, the motor, motor protectors, seals, sensors, etc. The ESP has both the motor and the pump submerged beneath the geothermal fluid level in the production well (200).

The production well (200) may also have a chemical injection line (208) disposed within the production liner (110) of the production well (200). The chemical injection line (208) extends from the surface location (114) and runs the length of the production well (200) to terminate in the production liner (110) near the open hole (112) section of the production well (200). The chemical injection line (208) may be made out of a corrosion resistant alloy material. The chemical injection line (208) may be used to inject chemicals, such as corrosion or scale inhibitors, into the production well (200) to prevent damage to the equipment downhole.

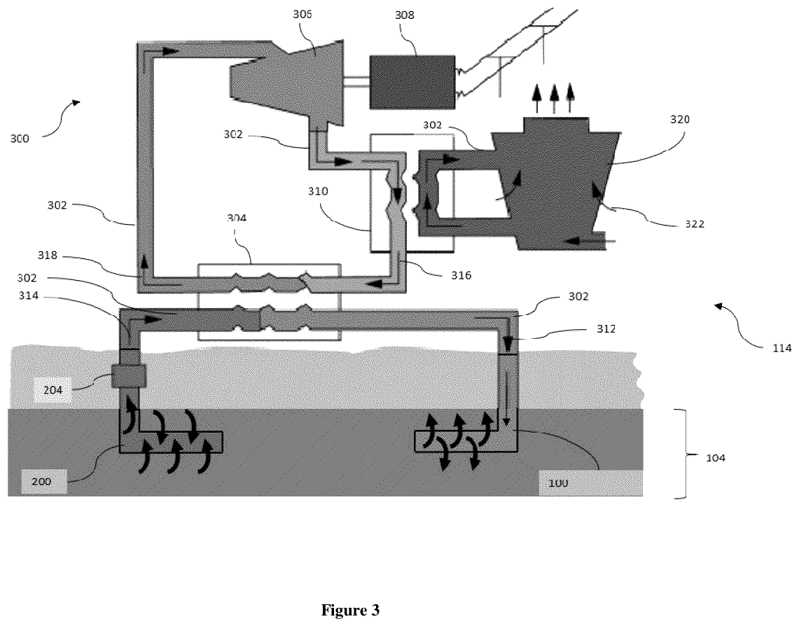

FIG. 3 shows a binary cycle system (300) in accordance with one or more embodiments. The binary cycle system (300) is shown being used in conjunction with one horizontally drilled injection well (100), as described in FIG. 1, and one horizontally drilled production well (200), as described in FIG. 2. The binary cycle system (300) is an example of a system that may be used to aid in producing geothermal energy using fluid produced from the production well (200); however, any method/system of producing geothermal energy from the horizontally drilled production well (200) and injection well (100) may be used without departing from the scope of this disclosure herein. Components of FIG. 3 that are the same as or similar to components described in FIGS. 1 and 2 have not been redescribed for purposes of readability and have the same description and function as outlined above.

The binary cycle system (300) includes pipelines (302), a heat exchanger (304), a turbine (306), a generator (308), and a condenser (310). The pipelines (302) provide a conduit to transport the heated geothermal fluid (314) from the production well (200) to the heat exchanger (304) and transport the cooled geothermal fluid (312) from the heat exchanger (304) to the injection well (100). The pipelines (302) may be any commercially available pipeline (302) known in the art that can withstand the pressures and temperatures seen in the binary cycle system (300). As discussed above, the injection well (100) takes cooled geothermal fluid (312) and injects the cooled geothermal fluid (312) into the geothermal reservoir (104) using various pumps (not pictured) located at the surface location (114). The cooled geothermal fluid (312) is heated in the geothermal reservoir (104) due to the geothermal reservoir (104) having higher temperatures than the temperature of the cooled geothermal fluid (312). The geothermal fluid (312, 314) may be any fluid such as brine or carbon dioxide. The heated geothermal fluid (314) is produced to the surface location (114) using the production well (200) and the production pump (204). The pipelines (302) transport the heated geothermal fluid (314) to the heat exchanger (304).

The heat exchanger (304) may be any heat exchanger (304) known in the art. In one or more embodiments, the heat exchanger (304) receives the heated geothermal fluid (314) having a temperature of less than 200 degrees Celsius, such as 120 degrees Celsius. The heat exchanger (304) transfers heat from the heated geothermal fluid (314) to a condensed working fluid (316). This transfer of heat cools down the heated geothermal fluid (314) to create the cooled geothermal fluid (312) that is injected back into the geothermal reservoir (104) using the injection well (100). The working fluid (316, 318) may be any fluid having a lower boiling point than the geothermal fluid (312, 314). The binary cycle system (300) may be an Organic Rankine Cycle (ORC) system. The ORC system uses an organic, high molecular mass fluid with a liquid-vapor phase, or boiling point, occurring at a lower temperature than the geothermal fluid (312, 314).

When the heat is transferred from the heated geothermal fluid (314) to the condensed working fluid (316), the condensed working fluid (316) vaporizes and becomes a vaporized working fluid (318). The vaporized working fluid (318) is transported to a turbine (306) using the pipelines (302). The expansion of the vaporized working fluid (318) rotates the turbine (306), and the turbine (306) drives the generator (308) to produce the geothermal energy. The turbine (306) and the generator (308) may be any turbine (306) and generator (308) known in the art. The vaporized working fluid (318) exits the turbine (306), using the pipelines (302), and enters the condenser (310) to condense and become the condensed working fluid (316). The condenser may be any condenser (310) known in the art. For example, the condenser (310) may be driven by a cooling tower (320) that takes in cool air (322) from an external environment to cool down and condense the working fluid (316, 318). The condenser (310) is hydraulically connected to the heat transfer, such as by the pipeline (302), to transport the condensed working fluid (316) to the heat exchanger (304) to start the process over again.

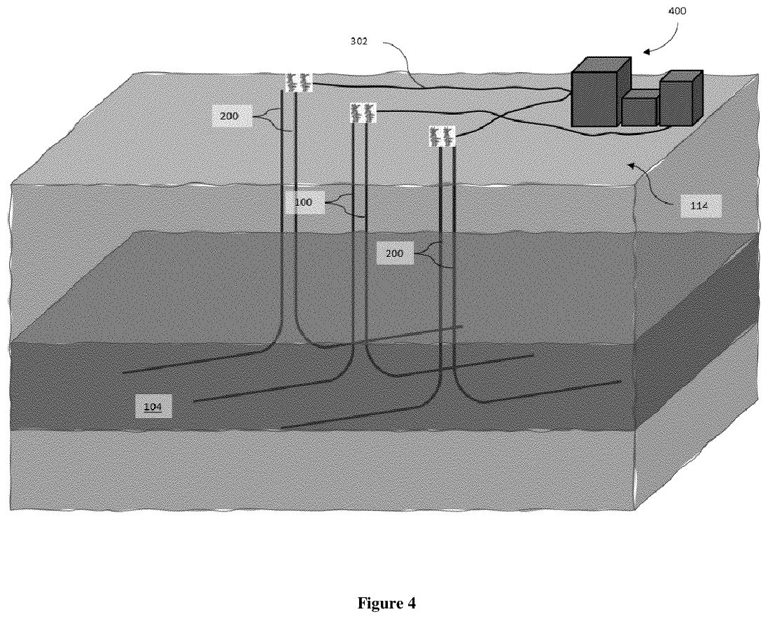

FIG. 4 shows a geothermal energy production field in accordance with one or more embodiments. The field includes the injection wells (100), as described in FIG. 1, and production wells (200), as described in FIG. 2, drilled into the geothermal reservoir (104). The field also includes a geothermal powerplant (400) that produces the geothermal energy. The geothermal powerplant (400) may use any geothermal production system, such as the binary cycle system (300) outlined in FIG. 3, to produce geothermal energy. Components of FIG. 4 that are similar to or the same as components described in FIGS. 1-3 have not been redescribed for purposes of readability and have the same description and function as described above.

FIG. 4 specifically shows six wells (100, 200) drilled to the same depth in the geothermal reservoir (104). There are three sets of wells (100, 200), each set having two wells (100, 200) pointing in opposite directions. Each set alternates production wells (200) and injection wells (100). For example, the first and the third set each show two production wells (200) extending in opposite directions. The second set shows two injection wells (100) extending in opposite directions. These sets create a total of four production wells (200) and two injection wells (100). This may be called a ribcage design. A ribcage design is the most effective way to sweep heat from the geothermal reservoir (104). In one or more embodiments, the field may include eighteen alternating wells (100, 200): eight injection wells (100) and ten production wells (200). Pipelines (302) are also shown in FIG. 4. The pipelines (302) bring the heated geothermal fluid (314) from the production wells (200) to the geothermal powerplant (400). The pipelines (302) also bring the cooled geothermal fluid (312) from the geothermal powerplant (400) to the injection wells (100).

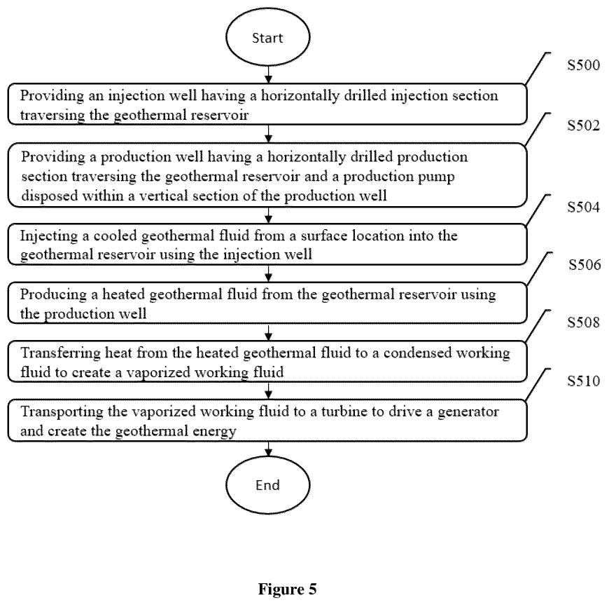

FIG. 5 depicts a flowchart in accordance with one or more embodiments. More specifically, FIG. 5 illustrates a method for producing geothermal energy from a geothermal reservoir (104). Further, one or more blocks in FIG. 5 may be performed by one or more components as described in FIGS. 1-4. While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Initially, an injection well (100) having a horizontally drilled injection section (102) traversing the geothermal reservoir (104) is provided (S500). A production well (200) having a horizontally drilled production section (202) traversing the geothermal reservoir (104) and a production pump (204) disposed within a vertical section of the production well (200) is provided (S502). Both the injection well (100) and the production well (200) may be completed with a barefoot completion scheme along a portion of the horizontally drilled injection section (102) and a portion of the horizontally drilled production section (202).

Both the injection well (100) and the production well (200) may have a surface casing (106), an intermediate casing (108), a production liner (110), and an open hole (112). The production well (200) may have a chemical injection line (208) disposed within the production liner (110) such that a chemical may be injected into the production liner (110). The chemical that may be injected may be a corrosion inhibitor to prevent the heated geothermal fluid (314) from corroding the internal components of the production well (200). In further embodiments, the production pump (204) is hung in the production well (200) on production tubing (206) and the production pump is an ESP.

A cooled geothermal fluid (312) is injected from a surface location (114) into the geothermal reservoir (104) using the injection well (100) (S504). The cooled geothermal fluid (312) may be brine, carbon dioxide, or a mixture of the two. If the cooled geothermal fluid (312) is carbon dioxide, the carbon dioxide may be sequestered in the geothermal reservoir (104) by injecting the carbon dioxide, in a liquid phase, into the geothermal reservoir (104) using the injection well (100). The cooled geothermal fluid (312) is heated while in the geothermal reservoir (104). A heated geothermal fluid (314) is produced from the geothermal reservoir (104) using the production well (200) (S506).

The heated geothermal fluid (314) may be brine, carbon dioxide, or a mixture of the two. Pipelines (302) may bring the heated geothermal fluid (314) from the production well (200) to a geothermal powerplant (400) to extract geothermal energy. The geothermal powerplant (400) may be utilizing a binary cycle system (300), such as an ORC system, to produce the geothermal energy. In the binary cycle system, heat is transferred from the heated geothermal fluid (314) to a condensed working fluid (316) to create a vaporized working fluid (318) (S508).

The vaporized working fluid (318) is transported to a turbine (306) to drive a generator (308) and create the geothermal energy (S510). The vaporized working fluid (318) is then transported to a condenser (310) to cool the vaporized working fluid (318) to create the condensed working fluid (316). The condenser (310) may be driven by a cooling tower (320) that utilizes air (322) to cool down the vaporized working fluid (318). The condensed working fluid (316) is then transported to the heat exchanger (304) to be vaporized again. When the heat is transferred from the heated geothermal fluid (314) to the condensed working fluid (316), the heated geothermal fluid (314) cools down and becomes the cooled geothermal fluid (312) that may be injected back into the geothermal reservoir (104) using the injection well (100).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A system for producing geothermal energy from a geothermal reservoir, the system comprising:
at least one injection well having a horizontally drilled injection section traversing the geothermal reservoir, through which a cooled geothermal fluid is injected, from a surface location, into the geothermal reservoir to be heated by the geothermal reservoir;
at least two production wells having a horizontally drilled production section traversing the geothermal reservoir and a production pump disposed within a vertical section, wherein the production pump pumps the heated geothermal fluid, which enters the production well from the geothermal reservoir, to the surface location,
wherein the at least one injection well and the at least two production wells are placed in alternating arrangement and wherein the horizontally drilled injection section and the horizontally drilled production sections are parallel to one another and traverse the geothermal reservoir along the same horizontal plane; and
a binary cycle system comprising:
a heat exchanger configured to transfer heat from the heated geothermal fluid to a condensed working fluid to create a vaporized working fluid; and
a turbine, rotated by the vaporized working fluid, wherein the turbine drives a generator to produce the geothermal energy.

2. The system of claim 1,
wherein the geothermal reservoir is a sedimentary basin located at a vertical depth of at least 3,500 m.

3. The system of claim 1,
wherein the injection well and the production well are completed with a barefoot completion scheme.

4. The system of claim 1,
wherein the injection well and the production well each comprise a surface casing, an intermediate casing, and a production liner; and
wherein the production well further comprises production tubing extending from the production pump to the surface location.

5. The system of claim 1,
wherein the system comprises at least one set of injection wells and at least two sets of production wells, wherein each set comprises two wells pointing in opposite directions, and wherein the at least one set of injection wells and the at least two sets of production wells are placed in alternating arrangement such that the horizontally drilled injection sections and the horizontally drilled production sections are parallel to one another and traverse the geothermal reservoir along the same horizontal plane.

6. The system of claim 1,
wherein the binary cycle system further comprises a condenser, driven by a cooling tower, configured to cool the vaporized working fluid to create the condensed working fluid and the condenser is hydraulically connected to the heat exchanger to transport the condensed working fluid to the heat exchanger.

7. A system for producing geothermal energy from a geothermal reservoir, the system comprising:
an injection well having a horizontally drilled injection section traversing the geothermal reservoir, through which a cooled geothermal fluid comprising sequestered carbon dioxide is injected, from a surface location, into the geothermal reservoir to be heated by the geothermal reservoir;
a production well having a horizontally drilled production section traversing the geothermal reservoir and a production pump disposed within a vertical section, wherein the production pump pumps the heated geothermal fluid, which enters the production well from the geothermal reservoir, to the surface location; and
a binary cycle system comprising:
a heat exchanger configured to transfer heat from the heated geothermal fluid to a condensed working fluid to create a vaporized working fluid; and
a turbine, rotated by the vaporized working fluid, wherein the turbine drives a generator to produce the geothermal energy.

8. The system of claim 7,
wherein the geothermal reservoir is a sedimentary basin located at a vertical depth of at least 3,500 m.

9. The system of claim 7,
wherein the injection well and the production well are completed with a barefoot completion scheme.

10. The system of claim 7,
wherein the injection well and the production well each comprise a surface casing, an intermediate casing, and a production liner.

11. The system of claim 10,
wherein the production well further comprises production tubing extending from the production pump to the surface location.

12. The system of claim 7,
wherein the binary cycle system further comprises a condenser, driven by a cooling tower, configured to cool the vaporized working fluid to create the condensed working fluid and the condenser is hydraulically connected to the heat exchanger to transport the condensed working fluid to the heat exchanger.

13. The system of claim 7,
wherein the system comprises at least one set of injection wells and at least two sets of production wells, wherein each set comprises two wells pointing in opposite directions, and wherein the at least one set of injection wells and the at least two sets of production wells are placed in alternating arrangement such that the horizontally drilled injection sections and the horizontally drilled production sections are parallel to one another and traverse the geothermal reservoir along the same horizontal plane.

14. A method for producing geothermal energy from a geothermal reservoir, the method comprising:
providing at least one injection well having a horizontally drilled injection section traversing the geothermal reservoir;
providing at least two production wells having a horizontally drilled production section traversing the geothermal reservoir and a production pump disposed within a vertical section of the production well;
injecting a cooled geothermal fluid from a surface location into the geothermal reservoir using the injection well;
producing a heated geothermal fluid from the geothermal reservoir using the production well;
transferring heat from the heated geothermal fluid to a condensed working fluid to create a vaporized working fluid; and
transporting the vaporized working fluid to a turbine to drive a generator and create the geothermal energy.

15. The method of claim 14,
wherein the at least one injection well and the at least two production wells are placed in alternating arrangement and wherein the horizontally drilled injection section and the horizontally drilled production section are parallel to one another and traverse the geothermal reservoir along the same horizontal plane.

16. The method of claim 15, wherein the method comprises:
providing at least one set of injection wells;
providing at least two sets of production wells;
wherein each set comprises two wells pointing in opposite directions, and wherein the at least one set of injection wells and the at least two sets of production wells are placed in alternating arrangement such that the horizontally drilled injection sections and the horizontally drilled production sections are parallel to one another and traverse the geothermal reservoir along the same horizontal plane.

17. The method of claim 14,
wherein transferring heat from the heated geothermal fluid to the condensed working fluid to create the vaporized working fluid further comprises cooling the heated geothermal fluid to create the cooled geothermal fluid using a heat exchanger.

18. The method of claim 17, further comprising:
cooling the vaporized working fluid to create the condensed working fluid using a condenser driven by a cooling tower; and
transporting the condensed working fluid to the heat exchanger.

19. The method of claim 18, further comprising:
providing a pipeline to transport the heated geothermal fluid from the production well to the heat exchanger and transport the cooled geothermal fluid from the heat exchanger to the injection well.

20. The method of claim 13, further comprising:
sequestering carbon dioxide in the geothermal reservoir by injecting the carbon dioxide, in a liquid phase, into the geothermal reservoir using the injection well.
